(19) United States
(12) Patent Application Publication
(10) Pub. No.: US 2024/0316637 A1
(43) Pub. Date: Sep. 26, 2024

(54) Method for Sintering an Assembly, and an Assembly

(71) Applicant: GKN Powder Metallurgy Engineering GmbH, Bonn (DE)

(72) Inventors: Christian Simon, Vogtei-Oberdorla (DE); Jack Schwarz, Gotha (DE); Wolfgang Schütz, Bad Tennsted (DE)

(21) Appl. No.: 18/579,217

(22) PCT Filed: Jul. 15, 2022
(86) PCT No.: PCT/EP2022/069868

§ 371 Date: Jan. 12, 2024

(30) Foreign Application Priority Data
Jul. 16, 2021 (DE) 10 2021 118 499.1

(51) Int. Cl. B22F 7/06; B22F 3/22

(52) U.S. Cl. CPC B22F 7/062; B22F 3/225; B22F 2998/10

(57) ABSTRACT

Method for sintering an assembly (1), wherein the assembly (1) comprises at least a first part (2) produced by powder metallurgy and a second part (3) produced by powder metallurgy; wherein the method comprises at least the following steps:
a) providing the first part (2) and the second part (3) each in the form of a green blank, with a green blank being produced from a powdered material by a metal injection moulding method;
b) providing a support structure part (4);
c) arranging the first part (2) and the second part (3) on the support structure part (4), wherein the support structure part (4) makes contact with at least the first part (2) at least at one first point of contact (5), wherein the second part (3) makes contact with at least the first part (2) or the support structure part (4) at least at one second point of contact (6);
d) jointly sintering the parts (2, 3) and the support structure part (4).

The invention relates to a method for sintering an assembly, and to an assembly. The assembly is produced by the method. The assembly comprises at least a first part produced by powder metallurgy and a second part produced by powder metallurgy.

The parts of the assembly are produced in particular by a metal injection moulding method or by binder jetting.

These methods share the feature that a structural part is initially produced from a mixture of binder and metal powder. The difference between these methods lies in the shaping of the structural part. While the mixture is injected into a mould in the case of the injection moulding method, in the case of binder jetting the mixture is arranged in layers (similarly to what is the case for 3D printing or generative methods), one on top of another, to form the structural part.

Both methods are referred to by the term “metal injection moulding method” below.

Metal injection moulding methods have been known for a long time. The metal injection moulding method comprises in particular at least the following steps: feedstock production, injection moulding, debindering, and sintering. The sintered structural part can then also be subjected to an aftertreatment. During the feedstock production, a fine metal powder, for example iron powder (and, if appropriate, additional other powdered additives, possibly nickel or chromium etc.), is mixed with an organic binder to form a homogeneous mass, which can be processed in an injection moulding process or an injection process in a similar way to the processing of plastic. This metal/plastics mixture is referred to as feedstock.

During the subsequent injection moulding, this feedstock is injected in liquefied form (usually at an elevated temperature) into a closed tool, where, owing to selective temperature control, it first completely fills the mould (cavity) and then plasticizes. In the case of binder jetting, the structural part is successively built up in layers from the feedstock material, which is applied in thin layers.

The resulting moulded part (green compact) already has all the typical geometric features of the finished structural part. During the subsequent debindering, after the green compact is removed from the injection moulding machine or from the binder jetting device, the binder is removed again in a two-stage process, the debindering. This produces a purely metallic structural part. The porous moulded part that remains after the debindering operation, now referred to as brown compact, is compacted by sintering at high temperature to form a structural part which has its final geometric and mechanical properties.

In the case of these metal injection moulding methods, the compacting operation that takes place during the sintering operation generally causes a large degree of shrinkage.

The parts are produced in particular from a powdered material by a metal injection moulding method to form green compacts and then by sintering to form solid workpieces (sintered part).

An assembly generally comprises multiple, possibly even more than two, parts, which must be produced separately from one another but always have a common functionality, i.e. always be used together, when the parts are in use.

In the case of the production of an assembly produced by powder metallurgy, it is known to produce the parts of the assembly individually by a metal injection moulding method and sinter them individually.

Produced by powder metallurgy means in particular that a part is produced at least partially from a powdered metallic material by a metal injection moulding method and sintering.

It is known that, in the case of the structural parts produced in this way, a not inconsiderable shrinkage, i.e. a reduction in the dimensions of the structural part, occurs during the sintering operation. Such parts therefore have defined points of contact on which they are supported during the sintering operation so as to keep their shape.

It is therefore known to provide a support structure, or a support structure part, which shrinks to the same extent as the respective part to be produced. As a result, even in the case of large degrees of shrinkage, for example 10% and more, it is possible to ensure that the component geometry of the part remains the same during the sintering operation, since as the structural part becomes smaller the points of contact, or the support points, also migrate.

DE 103 43 780 A1 describes the use of such a support structure (and refers to it as “holding device”) during a sintering operation.

However, a disadvantage is the increased use of material, since for each part to be produced a dedicated support structure—for a one-off use—must be produced.

An object of the present invention is to at least partially solve the problems set out with respect to the prior art. In particular, the intention is to propose a method for sintering an assembly which can be carried out more economically and in the case of which the produced parts of the assembly have sufficient dimensional stability.

A method having the features according to claim 1 contributes to achieving these objects. The dependent claims relate to advantageous developments. The features set out individually in the claims can be combined with one another in a way that makes sense from a technology perspective and can be supplemented by illustrative substantive matter from the description and/or details from the figures, which show other embodiment variants of the invention.

A method for sintering an assembly is proposed. The assembly comprises at least a first part produced by powder metallurgy and a second part produced by powder metallurgy. The method comprises at least the following steps:
a) providing the first part and the second part each in the form of a green blank, with a green blank being produced from a powdered material by a metal injection moulding method;
b) providing a support structure part;
c) arranging the first part and the second part on the support structure part, wherein the support structure part makes contact with at least the first part at least at one first point of contact, wherein the second part makes contact with at least the first part or the support structure part at least at one second point of contact;
d) jointly sintering the parts and the support structure part.

The above (non-exhaustive) division of the method steps into a) to d) should serve primarily only for differentiation purposes and is not intended to mandate an order and/or dependency. The frequency of the method steps can also vary, if appropriate. It is also possible for method steps to at least partially temporally overlap one another. The order of method steps a) and b) in particular can be freely selected. Steps c) and d) take place in particular after steps a) and b). The arrangement produced in step c) is very particularly preferably maintained during step d). In particular, steps a) to d) are carried out in the listed order.

It is proposed in particular to arrange multiple parts in a particular way relative to one another for the sintering operation according to step d). The arrangement according to step c) should in particular be effected such that a common support structure part can be used for two or more parts. The smallest number of components used for carrying out the method therefore consists of at least the first part, the second part and a support structure part.

In particular, the support structure part makes contact with at least the first part at least at one first point of contact or at a plurality of first points of contact. The contact-connections between the first part and the support structure part are thus referred to as first points of contact.

In particular, the second part makes contact with at least the first part or the support structure part at least at one second point of contact or at a plurality of second points of contact. The contact-connections between the second part and the other components, i.e. the first part and the support structure part, are thus referred to as second points of contact.

Points of contact which can be used to stabilize the parts, if appropriate also against one another, are thus provided between the different components, i.e. the first part, the second part and the support structure part. The part performing the stabilizing action thus takes on, if appropriate, the function of a support structure part with respect to the other part in the sintering operation but does not need to be separated as waste after the sintering operation, and instead can be reused as a part as was predetermined.

In the course of the present method, at least two parts which, after step d), can be fed for a further use and function are therefore produced, with only the support structure part being fed, for example, to a recycling process as waste.

According to step d), the components, i.e. the first part, the second part and the support structure part, are jointly sintered. In particular, during the sintering use is made of a temperature slightly below a melting temperature of the materials used, with the individual particles of the powdered materials of the respective components being integrally bonded to one another via what are referred to as sintering necks.

Connection of the materials of different components is preferably prevented. In particular, the points of contact can be designed suitably for this. In particular, it is possible, for example, for the points of contact on at least one component to have a coating.

In particular, after step d), the sintered first part and the sintered second part are assembled to form an assembly with a common functionality.

In particular, the first part and the second part have a predetermined common intended use and are thus in particular only used together to perform a function. In particular, the first part and the second part are connected to one another by connecting elements and thus form a functional unit, i.e. an assembly with a common function, or functionality.

In particular, the second part makes contact with the first part and the support structure part via a plurality of second points of contact.

In particular, the first part makes contact with the support structure part via a plurality of first points of contact.

In particular, the second part makes contact exclusively with the first part or exclusively with the support structure component via at least one second point of contact.

In particular, the second part makes contact (only) with the first part via a plurality of second points of contact. In particular, the second part makes contact (only) with the support structure part via a plurality of second points of contact.

In particular, a point of contact is formed by a mutual contact surface between two of the components, i.e., the parts and the support structure part. As an alternative, the point of contact may be in the form of a point/dot contact or a line contact.

In particular, the contact surface has a surface normal which, at least during step d), extends exclusively along the direction of gravitational force or transversely thereto.

The materials of the parts and of the support structure part in particular have degrees of shrinkage which deviate from one another by at most 5%, preferably by at most 2%, particularly preferably at most 1%. In particular, the degrees of shrinkage of the materials of the components do not deviate from one another but have the same magnitude.

A degree of shrinkage refers to the magnitude of a reduction in the dimensions of the structural part during the sintering operation. Therefore, if a length of a structural part is decreased by 10%, the degree of shrinkage is 0.1.

In particular, the first part, the second part and the support structure part are made from an identical powdered material.

An assembly produced by the described method is also proposed. The assembly comprises at least the sintered first part and the sintered second part. The parts have a common functionality in the assembly and are thus in particular only used together to perform a function.

The statements relating to the method can be transferred in particular to the assembly, and vice versa.

The use of the indefinite article (“a” and “an”), in particular in the claims and the description reproducing them, should be understood as such and not as a numeral (“one”). Accordingly, terms and components introduced thereby should be understood as meaning that they are present at least once, but in particular may also be present multiple times.

As a precaution, it is pointed out that the numerals (“first”, “second”, etc.) used here serve primarily (only) to differentiate multiple articles, sizes or processes of the same type, i.e. in particular do not necessarily imply any dependency and/or order of these articles, sizes or processes with respect to one another. Should a dependency and/or order be required, this is explicitly stated here and will be obvious to a person skilled in the art on studying the specifically described configuration. If a component can be present multiple times (“at least one”), the description for one of these components can apply equally to all or some of the plurality of these components, but this is not absolutely necessary.

The invention and the technical environment are explained in more detail below with reference to the appended figures. It should be noted that the invention is not intended to be limited by the exemplary embodiments listed. In particular, unless explicitly stated otherwise, it is also possible for partial aspects of the substantive matter explained in the figures to be extracted and combined with other constituent parts and insights from the present description.

In particular, it should be noted that the figures and in particular the relative sizes illustrated are only schematic. In the figures:

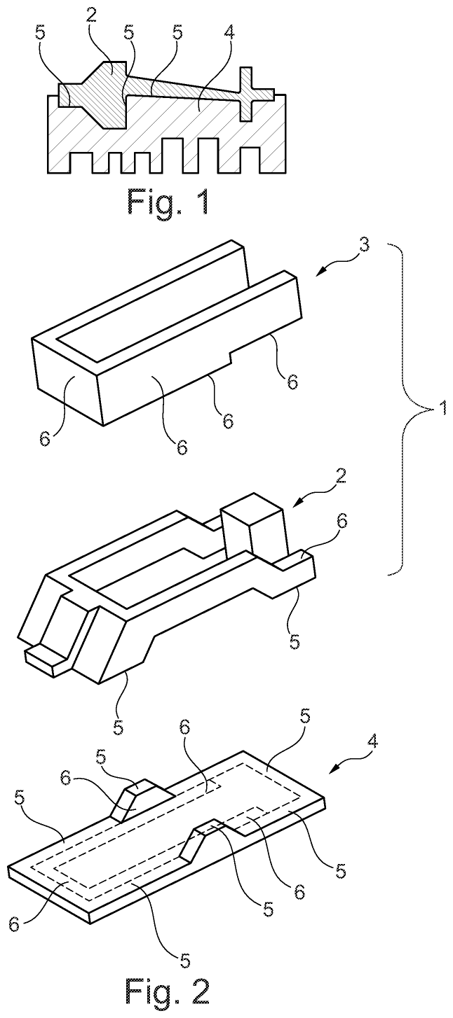

FIG. 1: shows a known method;

FIG. 2: shows an exploded illustration, in a perspective view, of an assembly and a support structure part;

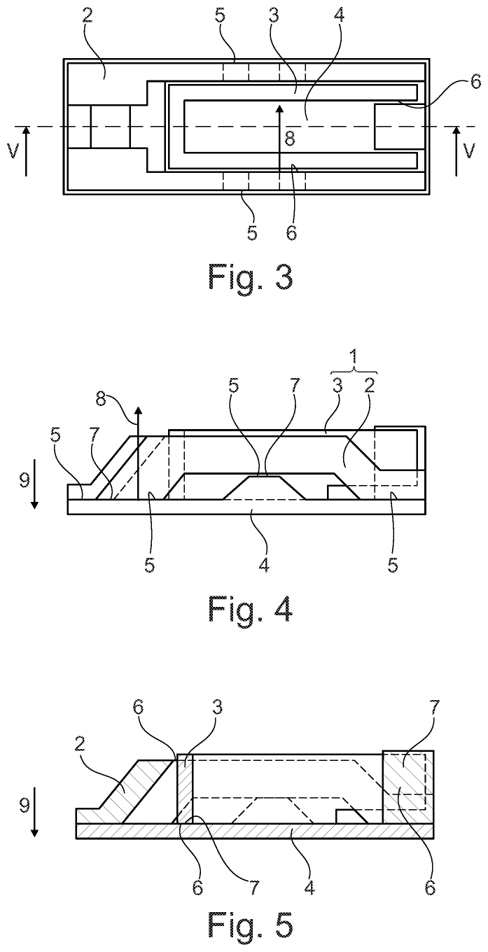

FIG. 3: shows a plan view of the components according to FIG. 2;

FIG. 4: shows a side view of the components according to FIG. 3; and

FIG. 5: shows a side view, in the section V-V, of the components according to FIGS. 3 and 4.

FIG. 1 shows a known method. In the method, a support structure part 4 is provided for each part 2 to be produced. The support structure part 4 shrinks to the same extent as the respective part 2 to be produced. As a result, even in the case of large degrees of shrinkage, for example 10% and more, it is possible to ensure that the component geometry of the part 2 remains the same during the sintering operation, since as the structural part becomes smaller the points of contact 5, or the support points, also migrate.

FIG. 2 shows an exploded illustration, in a perspective view, of an assembly 1 and a support structure part 4. FIG. 3 shows a plan view of the components 2, 3, 4 according to FIG. 2.

FIG. 4 shows a side view of the components 2, 3, 4 according to FIG. 3. FIG. 5 shows a side view, in the section V-V, of the components 2, 3, 4 according to FIGS. 3 and 4. FIGS. 2 to 5 are described together below.

The assembly 1 comprises a first part 2 produced by powder metallurgy and a second part 3 produced by powder metallurgy. Step a) involves providing the first part 2 and the second part 3 each in the form of a green blank, with a green blank being produced from a powdered material by a metal injection moulding method. Step b) involves providing a support structure part 4. Step c) involves arranging the first part 2 and the second part 3 on the support structure part 4 (see FIGS. 3 to 5), with the support structure part 4 making contact with the first part 2 at a plurality of first points of contact 5 and the second part 3 making contact with the first part 2 and the support structure part 4 at a respective plurality of second points of contact 6. Step d) involves jointly sintering the parts 2, 3 and the support structure part 4.

The support structure part 4 makes contact with the first part 2 at a plurality of first points of contact 5. The contact-connections between the first part 2 and the support structure part 4 are thus referred to as first points of contact 5.

The second part 3 makes contact with the first part 2 and the support structure part 4 at a respective plurality of second points of contact 6. The contact-connections between the second part 3 and the other components 2, 4, i.e. the first part 2 and the support structure part 4, are thus referred to as second points of contact 6.

Points of contact 5, 6 which can be used to stabilize the parts 2, 3, if appropriate also against one another, are thus provided between the different components, i.e. the first part 2, the second part 3 and the support structure part 4. The part 2, 3 performing the stabilizing action thus takes on the function of a support structure part 4 with respect to the other part 3, 2 in the sintering operation, but does not need to be separated as waste after the sintering operation, and instead can be reused as a part 2, 3 as was predetermined.

In the course of the present method, two parts 2, 3 which, after step d), can be fed for a further use and function are therefore produced, with only the support structure part 4 being fed, for example, to a recycling process as waste.

A point of contact 5, 6 is formed by a mutual contact surface 7 between two of the components, i.e. the parts 2, 3 and the support structure part 4. As an alternative, the point of contact 5, 6 may be in the form of a point/dot contact or a line contact.

The contact surfaces 7 each have a surface normal 8 which, at least during step d), extends exclusively along the direction of gravitational force 9 or transversely thereto.

### LIST OF REFERENCE SIGNS

1 Assembly
2 First part
3 Second part
4 Support structure part
5 First point of contact
6 Second point of contact
7 Contact surface
8 Surface normal
9 Direction of gravitational force

1. A method for sintering an assembly, wherein the assembly comprises at least a first part produced by powder metallurgy and a second part produced by powder metallurgy, the method comprising at least the following steps:
a) providing the first part and the second part each in the form of a green blank, with a green blank being produced from a powdered material by a metal injection moulding method;
b) providing a support structure part;
c) arranging the first part and the second part on the support structure part, wherein the support structure part makes contact with at least the first part at least at one first point of contact, wherein the second part makes contact with at least the first part or the support structure part at least at one second point of contact;
d) jointly sintering the parts and the support structure part.

2. The method according to claim 1, wherein, after step d), the sintered first part and the sintered second part are assembled to form the assembly with a common functionality.

3. The method according to claim 1, wherein the second part makes contact with the first part and the support structure part via a plurality of second points of contact.

4. The method according to either of the preceding claim 1, wherein the second part makes contact exclusively with the first part or exclusively with the support structure part via at least one second point of contact.

5. The method according to claim 1, wherein a point of contact is formed by a mutual contact surface between two of the components, i.e. of the parts and the support structure part; wherein the contact surface has a surface normal which, at least during step d), extends exclusively along the direction of gravitational force or transversely thereto.

6. The method according to claim 1, wherein the materials of the parts and of the support structure part have degrees of shrinkage which deviate from one another by at most 5%.

7. The method according to claim 1, wherein the first part, the second part and the support structure part are produced from an identical powdered material.

8. An assembly, produced by a method according to claim 1, at least comprising the sintered first part and the sintered second part; wherein the parts have a common functionality in the assembly.
